(19) United States
(12) Patent Application Publication
(10) Pub. No.: US 2007/0159341 A1
(43) Pub. Date: Jul. 12, 2007

(54) Packaging structure for radio frequency identification devices

(75) Inventors: Shun-Chi Chang, Taipei (TW); Guo-Tung Chiang, Taipei (TW); Chun-Ping Wu, Sinjhuang City (TW); Mei-Yi Wu, Taipei (TW); Cheng-Hsien Chou, Taipei City (TW)

Correspondence Address: Howard Chen, Esq.;Kirkpatrick & Lockhart Preston Gates Ellis LLP, Suite 1700, 55 Second Street, San Francisco, CA, 94150, US

(73) Assignee: YUEN FOONG YU PAPER MFG. CO., LTD.

(21) Appl. No.: 11/651,326

(22) Filed: Jan. 9, 2007

Related U.S. Application Data
(60) Provisional application No. 60/764,241, filed on Jan. 31, 2006.
(60) Provisional application No. 60/757,338, filed on Jan. 9, 2006.

(51) Int. Cl. G08B 13/14

(52) U.S. Cl. 340/572.8

(57) ABSTRACT

A packaging structure for a radio frequency identification (RFID) device is disclosed which comprises a substrate, an antenna with a plurality of terminals formed on the substrate, a RFID chip with a plurality of signal pins electrically coupled to the plurality of terminals, respectively, and a plurality of thermally activated binding pads being electrically conductive and in contact with the plurality of signal pins, respectively, wherein the RFID chip is adhered to the substrate by the plurality of binding pads after a thermo-pressing process.

### CROSS REFERENCE

The present application claims the benefit of U.S. Provisional Application Ser. 60/764,241, titled “METHOD FOR PACKAGING RFID DEVICES”, which was filed on Jan. 31, 2006.

### BACKGROUND

The present invention relates generally to packaging of microelectronic devices, and more specifically to packaging of radio frequency identification (RFID) devices.

A RFID device, in general, comprises an integrated circuit (IC) chip and an antenna. Conventionally antennas of the RFID devices are usually made of copper which has a better electrical conduction and of aluminum which costs less. In a RFID device manufacturing process, patterned thin sheet metal is adhered onto a surface of a substrate to form the antenna. A newer technology uses a printing method that prints an electrically conductive ink containing silver or carbon in an antenna pattern onto a substrate.

However, there are some major considerations in manufacturing the RFID devices through the printing processes. A first consideration is to achieve a reasonable conductivity for the electrically conductive ink, which relies on progresses of the ink manufacturers to increase conductivity while lowering the price of the ink. A second consideration is how to control the thickness of the film of the electrically conductive ink when printing it to the substrate which is mostly done by screen, plate or gravure printing. If a printed-ink antenna is too thin, its performance for receiving and sending signals will be reduced. On the other hand, if a printed-ink antenna is too thick, although its performance is enhanced, a cost of making such ink antenna is higher. Then a third consideration is how to test a printed-ink antenna with a RFID chip adhered thereto in a mass-production environment. The above considerations will have significant effect on the performances of the RFID devices.

Most IC chips are manufactured on silicon substrate, and conventionally packaged in either plastic or ceramic material. These materials are rigid, relatively bulky and expensive for the manufacturing processes. But in certain applications, flexibility and low cost are of major concern. A RFID device is one of such applications. It has to be flexible enough to be attached to any surface. Besides, the conventional chip packaging method is much more complicated than attaching the RFID chip to a RFID antenna substrate. For instance, a conventional IC chip packaging equipment can only package 4,000 to 5,000 chips per hour. As a comparison, a RFID device packaging equipment is required to package 100,000 to 200,000 pieces per hour. Therefore, there is a efficiency discrepancy between packaging a RFID chip and assembling it into an RFID device.

In conventional RFID packaging method, certain electrically conductive glue or other glues are often used to hold a RFID chip to a RFID antenna. The use of such adhesive material inevitably increases costs of the RFID devices.

As such, what is desired is a rapid and low cost packaging manufacturing method for the RFID devices.

### SUMMARY

In view of the foregoing, the present invention provides a packaging structure for a radio frequency identification (RFID) device. The packaging structure comprises a substrate, an antenna with a plurality of terminals formed on the substrate, a RFID chip with a plurality of signal pins electrically coupled to the plurality of terminals, respectively, and a plurality of thermally activated binding pads being electrically conductive and in contact with the plurality of signal pins, respectively, wherein the RFID chip is adhered to the substrate by the plurality of binding pads after a thermo-pressing process.

According to a first embodiment of the present invention, the plurality of the binding pads form parts of the plurality of the terminals of the antenna, respectively, wherein the plurality of signal pins of the RFID chips contact directly with the plurality of the terminals, respectively.

According to a second embodiment of the present invention, the plurality of the binding pads are formed on one or more connector strips and electrically connect the plurality of signal pins and the plurality of terminals, respectively.

The construction and method of operation of the invention, however, together with additional objects and advantages thereof will be best understood from the following description of specific embodiments when read in connection with the accompanying drawings.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein. It should be noted that the features illustrated in the drawings are not necessarily drawn to scale.

FIG. 1A is a top view of a RFID antenna formed on a substrate.

FIG. 1B is a top view of a RFID device with a RFID chip electrically connected to the antenna through a connector strip according to a first embodiment of present invention.

FIGS. 2A through 2C are side views showing a process of assembling the connector strip to the substrate according to the first embodiment of the present invention.

FIG. 3 is a top view showing a RFID chip made direct contact to the antenna according to a second embodiment of the present invention.

FIGS. 4A and 4B are side views showing a process of assembling the RFID chip directly to the substrate according to the second embodiment of the present invention.

### DESCRIPTION

The following will provide a detailed description of a structure and method for packaging a radio frequency identification (RFID) device.

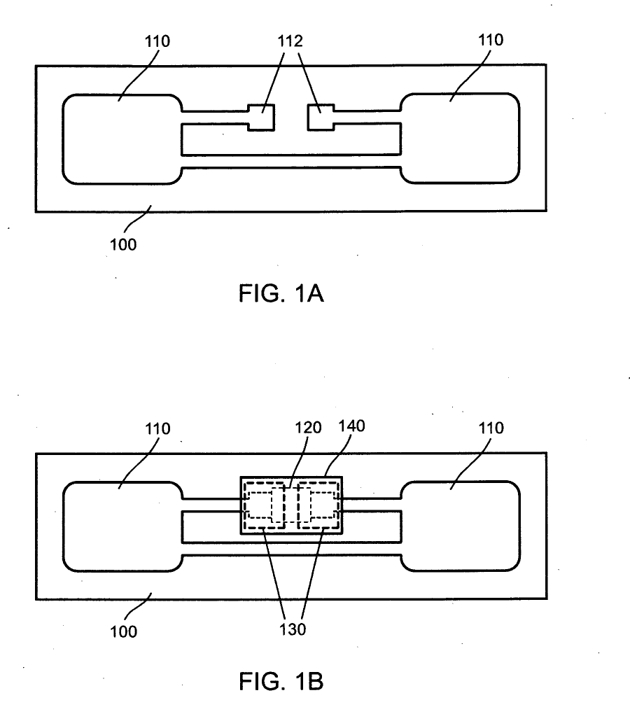

FIG. 1A is a top view of a RFID antenna 110 formed on a substrate 100. The antenna 110 may be made of a patterned metal foil either adhered or electroplated onto the substrate 100. The metal may be copper or aluminum. The antenna 110 may also be made of electrically conductive ink printed on the surface of the substrate 100. The electrically conductive ink may comprise silver ink, silver powder, gold powder, carbon powder, copper paste or tin paste. Referring to FIG. 1A, the antenna 110 has two contact pads 112 for making connections to an RFID chip.

FIG. 1B is a top view of a RFID device with a RFID chip 120 electrically connected to the antenna 110 through a connector strip 140 according to a first embodiment of present invention. The connector strip 140 has two connector pads 130 for connecting two signal pins on the RFID chip to the contact pads 112 of the antenna 110. The contact pads 112 serves as terminals of the antenna 110. Both the contact pads 112 and connector pads 130 are exposed, i.e., when contacts are made to them, electrical connection thereto will be established.

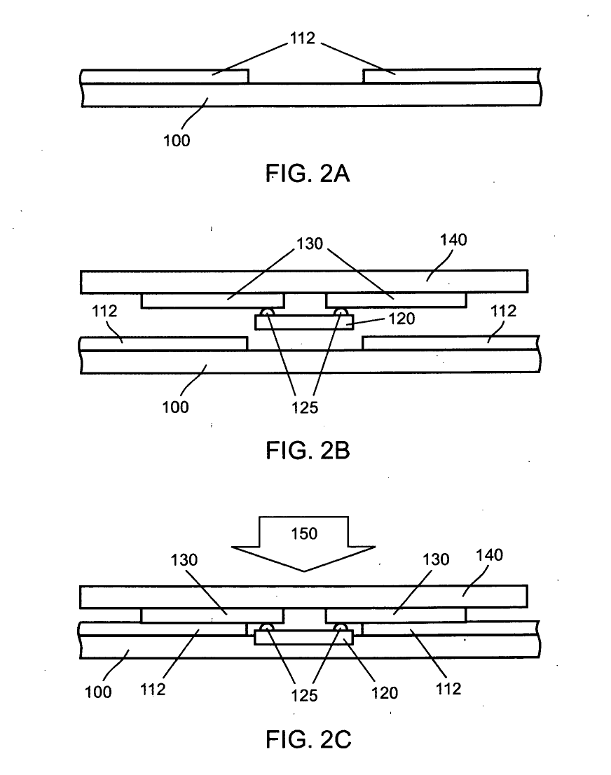

FIGS. 2A through 2C are side views showing a process of assembling the connector strip to the substrate according to the first embodiment of the present invention. FIG. 2A shows the antenna 110 with two contact pads 112 formed on the substrate 100. FIG. 2B shows a connector strip 140 has two connector pads 130 adhered to its bottom surface of the connector strip 140, which are spaced and aligned to a pair of signal pins 125 of a RFID chip 120. The connector pads 130 may be formed through printing a conductive material, such as silver ink, copper or tin paste, onto the bottom surface of the connector strip 140. Such conductive material may become adhesive when heated, i.e., thermally activated. In order to bond the connector strip 140 to the substrate 100, either the contact pads 130 or the antenna 110 or both must contain the conductive material.

Referring to FIG. 2C, after the RFID chip 120 and the connector strip 140 are placed on the substrate 100 with the connector pads 130 aligned to the antenna contact pad 112, the connector strip 140 along with the RFID chip 120 is pressed into the substrate 100 through a thermo-pressing process 150, so that a connector pad 130 makes firm contacts with both a signal pin 125 and a contact pad 112, hence electrically connects the two, and at the same time binds the connector strip 140 along with the RFID chip 120 to the substrate 100. The thermo-pressing process refers to raising temperature while applying a pressure.

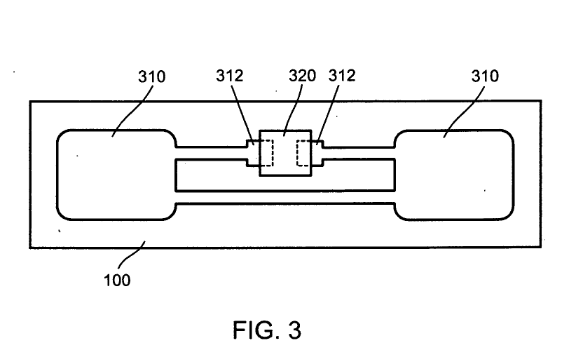

FIG. 3 is a top view showing a RFID chip 320 made direct contact to antenna contact pads 312 of an antenna 310 according to a second embodiment of the present invention. The contact pads 312, which serve as terminals of the antenna 310, are so spaced to allow signal pins of the RFID chip 320 to make direct contacts thereto. Then the connector strip 140 of the first embodiment of the present invention is eliminated, and therefore assembling cost of such RFID device is further reduced.

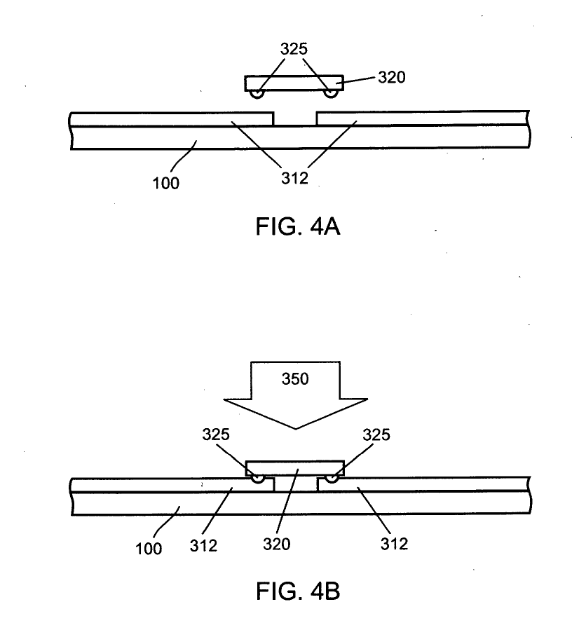

FIGS. 4A and 4B are side views showing a process of assembling the RFID chip 320 directly onto the substrate 100 according to the second embodiment of the present invention. Here a RFID chip 320 is placed face down on the substrate 100 with signal pins 325 come into direct contact with the contact pads 312. The material that forms the antenna 310, and particularly the contact pads 312 area becomes adhesive when being exposed to a temperature above a certain level. Referring to FIG. 4B, after the RFID chip 320 being placed on the substrate 100 with signal pins 325 come into contact with the contact pads 312, a thermo-pressing process 350 is applied, which turns the contact pads 312 adhesive, and therefore, not only the signal pins 325 are electrically connected to the antenna 310, but also the RFID chip 320 is attached to the substrate 100.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A packaging structure for a radio frequency identification (RFID) device, the packaging structure comprising:
a substrate;
an antenna with a plurality of terminals formed on the substrate;
a RFID chip with a plurality of signal pins electrically coupled to the plurality of terminals, respectively; and
a plurality of thermally activated binding pads being electrically conductive and in contact with the plurality of signal pins, respectively,
wherein the RFID chip is adhered-to the substrate by the plurality of binding pads after a thermo-pressing process.

2. The packaging structure of claim 1, wherein the substrate is made of a material selected from a group consisting of plastic and paper.

3. The packaging structure of claim 1, wherein the antenna is made of a material selected from the group consisting of copper foil, aluminum foil, silver ink, silver powder, gold powder, carbon powder, copper paste and tin paste.

4. The packaging structure of claim 1, wherein the plurality of binding pads are formed by electrically conductive ink through a printing process.

5. The packaging structure of claim 1, wherein the plurality of the binding pads form parts of the plurality of the terminals of the antenna, respectively, wherein the plurality of signal pins of the RFID chips contact directly with the plurality of the terminals, respectively.

6. The packaging structure of claim 1, wherein the plurality of the binding pads are formed on one or more connector strips and electrically connect the plurality of signal pins and the plurality of terminals, respectively.

7. A packaging structure for a radio frequency identification (RFID) device, the packaging structure comprising:
a substrate;
an antenna formed on the substrate having a plurality of terminals made of a thermally activated and electrically conductive binding material; and
a RFID chip with a plurality of signal pins contacted directly to the plurality of terminals, respectively,
wherein the RFID chip is adhered to the substrate by the plurality of terminals after a thermo-pressing process.

8. The packaging structure of claim 7, wherein the substrate is made of a material selected from a group consisting of plastic and paper.

9. The packaging structure of claim 7, wherein the antenna is made of a material selected from the group consisting of copper foil, aluminum foil, silver ink, silver powder, gold powder, carbon powder, copper paste and tin paste.

10. The packaging structure of claim 7, wherein the plurality of terminals are formed by electrically conductive ink through a printing process.

11. A packaging structure for a radio frequency identification (RFID) device, the packaging structure comprising:
a substrate;
an antenna with a plurality of terminals formed on the substrate;
a plurality of electrically conductive connector pads made of a thermally activated binding material; and
a RFID chip with a plurality of signal pins electrically coupled to the plurality of terminals by the plurality of connector pads, respectively,
wherein the RFID chip is adhered to the substrate by the plurality of connector pads after a thermo-pressing process.

12. The packaging structure of claim 11, wherein the substrate is made of a material selected from a group consisting of plastic and paper.

13. The packaging structure of claim 11, wherein the antenna is made of a material selected from the group consisting of copper foil, aluminum foil, silver ink, silver powder, gold powder, carbon powder, copper paste and tin paste.

14. The packaging structure of claim 11 further comprising one or more connector strips wherein the plurality of connector pads are formed thereon.

15. The packaging structure of claim 14, wherein the connector strips are made of a material selected from a group consisting of plastic and paper.
